(19) United States
(12) Patent Application Publication
(10) Pub. No.: US 2025/0110038 A1
(43) Pub. Date: Apr. 3, 2025

(54) Test Chamber System and Method

(71) Applicant: Weiss Technik GmbH, Reiskirchen (DE)

(72) Inventors: Lars Gscheidle, Geislingen (DE); Marcel Droessler, Gießen (DE)

(21) Appl. No.: 18/834,868

(22) PCT Filed: Jan. 30, 2023
(86) PCT No.: PCT/EP2023/052196

§ 371 Date: Jul. 31, 2024

(30) Foreign Application Priority Data
Feb. 2, 2022 (DE) 10 2022 102 400.8

(51) Int. Cl. G01N 17/00; H01M 10/42

(52) U.S. Cl. CPC G01N 17/002; H01M 10/4285

(57) ABSTRACT

A test chamber system includes a test chamber, the test chamber having a test space for receiving a test object, in particular a battery, and a pressure relief device. The test space serving to subject the test object to a test, in particular an abuse test, as a result of which a preferably explosive increase in pressure is triggered in the test space, the pressure relief device being configured to relieve the increased pressure in the test space. The test chamber system includes a conditioning unit for conditioning air, the conditioning unit being connected to the test chamber in such a manner that the conditioning unit is able to air-condition the test chamber.

### CROSS-REFERENCE TO RELATED APPLICATIONS

This application represents the U.S. national stage entry of International Application No. PCT/EP2023/052196 filed Jan. 30, 2023, which claims priority to German Patent Application No. 10 2022 102 400.8 filed Feb. 2, 2022, the disclosure of which is incorporated herein by reference in its entirety for all purposes.

### TECHNICAL FIELD

The disclosure relates to a test chamber system comprising a test chamber and to a method for relieving pressure in a test chamber of a test chamber system, the test chamber having a test space for receiving a test object, in particular a battery, the test space serving to subject the test object to a test, in particular an abuse test, as a result of which a preferably explosive increase in pressure is triggered in the test space.

### BACKGROUND

From the state of the art, it is known for a battery or a battery cell to be subjected to an abuse test, which is supposed to simulate false use or misuse, such as an extremely high or low temperature, mechanical damage or extraordinary electrical stress, such as a short circuit, overcharge or deep discharge. This typically involves forced destruction of the battery using an accordingly configured test chamber, the battery being disposed in a test space of the test chamber and then destroyed, for example by nail penetration brought about by means of a penetration device of the test chamber The destruction of the battery leads to an explosion with hydrogen and other gases. It has to be possible for an accompanying shockwave to be abruptly dissipated from the test space. Typically, an open container or a bunker serves as the test space, which allows the shockwave to be easily dissipated from the test space. Any (highly) toxic gases produced during the test simply escape into the environment. Moreover, the use of a container or a bunker as the test space does not allow testing a test object under recurring, in particular climatic, simulation conditions.

Furthermore, a test chamber for conditioning air is known from the state of the art, the test chamber having a test space for receiving the test material, the test space being configured to be sealed from an environment and being temperature-insulated, and a temperature control device for controlling the temperature of the test space. A test chamber or climate cabinet of this type, which can be seen, for example, in DE 10 2016 204 378 A1, is regularly used to test the physical and/or chemical properties of test material. The test material is placed in the test space and temperature-controlled using the temperature control device. However, such a test chamber is not suitable for conducting an abuse test on a battery, in particular due to a lack of explosion protection of the test chamber and its components and an inability to abruptly dissipate a shockwave from the test space.

### SUMMARY

Hence, the object of the present disclosure is to propose a test chamber system and a method for relieving pressure in a test chamber of a test chamber system which enables improved performance of a test, in particular an abuse test, on a test object, in particular a battery.

This object is attained by a test chamber system and a method having the features as disclosed herein.

The test chamber system according to the disclosure comprises a test chamber, the test chamber having a test space for receiving a test object, in particular a battery, and a pressure relief device, the test space serving to subject the test object to a test, in particular an abuse test, as a result of which a preferably explosive increase in pressure is triggered in the test space, the pressure relief device being configured to relieve the increased pressure in the test space, the test chamber system comprising a conditioning unit for conditioning air, the conditioning unit being connected to the test chamber in such a manner that the conditioning unit is able to air-condition the test chamber.

The test chamber system according to the disclosure comprises a test chamber, the test chamber having a test space for receiving a test object and a pressure relief device for relieving the pressure in the test chamber or the test space. The test object can be received in the test space in order to carry out the test. The test object can be a battery or a battery cell, and the test can be an abuse test, which can simulate false use or misuse, such as an extremely high or low temperature, mechanical damage or extraordinary electrical stress, such as a short circuit, overcharge or deep discharge. For example, the battery can be destroyed as a result of a nail penetration brought about by means of a penetration device of the test chamber. As a result of the abuse test, an explosive increase in pressure can be triggered in the test space. The test can also be a high-voltage test, in which high currents introduced into the test space or the test object can lead to the formation of an arc, which can discharge with high thermal energy. An accompanying rapid rise in temperature of the air in the test space can also lead to an explosive increase in pressure in the test space. Advantageously, the test chamber or the test space can be explosion-proof or explosion-resistant in order to withstand the explosive increase in pressure and the associated shockwave that occurs during a test of the test object without being destroyed. The pressure relief device can be used to relieve the pressure in the test chamber or the test space in the event of an increase in pressure or overpressure or to dissipate the shockwave from the test space.

The test chamber system according to the disclosure also comprises a conditioning unit for conditioning air, the conditioning unit being connected to the test chamber or to the test space in such a manner that the conditioning unit can air-condition or temperature-control the test chamber or the test space. Accordingly, the test chamber system comprises, in addition to the test chamber, a conditioning unit configured to air-condition the test chamber or the test space. This means that a test can be carried out under recurring, in particular climatic, simulation conditions. The conditioning unit is connected to the test chamber or the test space in such a manner that conditioned or temperature-controlled air can pass from the conditioning unit to the test chamber or into the test space. In other words, the conditioning unit is used to condition or temperature-control the test space.

Advantageously, the test space can be sealed from an environment and be temperature-insulated. Since the components required for air conditioning are essentially disposed separately from the test chamber in a conditioning unit, only a few special or simple protective measures are required to protect these components from an explosive increase in pressure or an associated shockwave occurring in the test chamber or in the test space. For example, a gate valve or pipe gate or a non-return valve can be provided in at least one conduit of the test chamber system connecting the conditioning unit to the test chamber or in a supply air connection of the test chamber or an exhaust air connection of the test chamber, which can prevent the conditioning unit from being destroyed as a result of a shockwave. The shockwave can be dissipated completely or essentially completely by means of the pressure relief device of the test chamber. Advantageously, the test chamber and the conditioning unit are modular in design. Furthermore, the test space can be designed as a double-shell structure with an inner shell forming an insulated or temperature-insulated test box for receiving the test object and an outer shell forming a housing enclosing the test box. The test box to be temperature-controlled can be of a lightweight construction with the lowest possible mass, allowing the test box to be temperature-controlled or its temperature to be changed in a thermally favorable manner.

As a result, the test chamber system according to the disclosure thus enables a simplified performance of a test, in particular an abuse test, on a test object, in particular a battery.

The conditioning unit can advantageously be designed as a conditioning module or an external module. The conditioning unit can then be disposed at a distance from the test chamber. Alternatively, the conditioning unit can also be disposed directly on the test chamber, in particular on the side of the test chamber. In this case, the conditioning unit can also be attached to the test chamber, in particular in a detachable manner, making the entire test chamber system compact and, depending on the design, additionally mobile or movable.

Advantageously, the test chamber system can comprise at least one conduit, preferably two conduits, via which the conditioning unit can be connected to the test chamber. The conduit can be a pipe or a hose. Furthermore, the test chamber system can comprise a rack on which the conduit can be supported. If two conduits are provided, a first conduit can be provided for the supply air and a second conduit can be provided for the exhaust air. The two conduits can then form a convection air circuit with the test chamber and the conditioning unit. If only one conduit is provided, it can be used for supplying air.

In an embodiment, the conditioning unit can form a further test chamber, in particular a climate chamber, which can have a further test space for receiving test material, the further test space being configured to be sealed from an environment and being temperature-insulated. In other words, a test chamber for conditioning air or a climatic cabinet that is actually primarily used to test the physical and/or chemical properties of test material that can be received in a test space of the test chamber for conditioning air can be used as a further test chamber for conditioning the test chamber of the test chamber system. The further test space can then be connected to the test space. Advantageously, if a user already has such a test chamber for conditioning air available, the user only needs to purchase a test chamber with a pressure relief device and a test space and possibly purchase a conduit in order to combine the two test chambers to form the test chamber system according to the disclosure and subsequently to be able to test a test object. Furthermore, the test chamber for conditioning air may then be switched from a mode in which the test chamber for conditioning air can be used to test physical and/or chemical properties of test material to a further mode, in which the test chamber for conditioning air can be used to air-condition the test chamber of the test chamber system. While the test chamber is being used to condition air for the purpose of air-conditioning the test chamber of the test chamber system or as an additional test chamber, the test space of the test chamber for conditioning air or the additional test chamber can be free of test material. Advantageously, the conditioning unit can have a temperature control device.

Advantageously, the temperature control device can be used to establish a temperature in a temperature range from −70° C. to +180° C., preferably from −55° C. to +150° C., in particular within the further test space. By connecting the conditioning unit to the test chamber, temperatures in this temperature range can then also be established within the test space. The test chamber can be designed to be temperature-resistant for temperatures in this temperature range. Furthermore, the test chamber can be designed to be temperature-resistant for a short-term peak load up to a temperature of +1100° C. Advantageously, the temperature control device can have a cooling device comprising a cooling circuit with a refrigerant, a heat exchanger, a compressor, a condenser, and an expansion member. The heat exchanger of the cooling circuit can be disposed in such a manner that air circulated by a fan or a ventilator of the temperature control device can come into contact with the heat exchanger. This makes it possible to cool the circulated air using the cooling device via the heat exchanger. The heat exchanger can in turn be connected to or integrated in the cooling circuit, allowing the refrigerant circulating in the cooling circuit to flow through the heat exchanger. The cooling device can also have the compressor and the condenser for the compressed refrigerant, the condenser being disposed downstream of the compressor in a flow direction of the refrigerant. The compressed refrigerant, which can be under high pressure and essentially in a gaseous state after compression, can condense in the condenser and then be essentially in a liquid state. The liquid refrigerant can then flow through the expansion member, where it can become gaseous again due to expansion as a result of a drop in pressure. In doing so, it can flow through the heat exchanger, which can be cooled as a result. The gaseous refrigerant can subsequently be aspirated again by the compressor and be compressed. The term expansion member refers to an expansion valve, a throttle, a throttle valve or any other suitable restriction in a fluid line.

The temperature control device can advantageously have a heating device with a heater and a further heat exchanger. The heating device can, for example, be an electrical resistance heater that can heat the second heat exchanger in such a manner that a temperature increase is made possible via the further heat exchanger. If the heat exchanger and the further heat exchanger can be controlled in a targeted manner by means of a control device for cooling or heating the circulated air, a temperature in the temperature range from −70° C. to +180° C., preferably from −55° C. to +150° C., can then be established by means of the temperature control device.

Alternatively, the conditioning unit can be formed by a heating device, in particular as a convection heating device or a hot-air gun, for heating, in particular on one side, without convection or only via supply air. A temperature in a temperature range from +20° C. to +200° C. can then be established using the heating device or a temperature control device of the heating device. Since the heating device does not require refrigeration technology, this makes it possible to produce the test chamber system or the conditioning unit at low cost. The convection heating device can have a fan and/or a counter-control for final value control with compressed air. Furthermore, the hot-air gun can have a heating element that can be switched on and off in a clocked or controlled manner.

The conditioning unit can advantageously have a control device for controlling and/or regulating a temperature.

Advantageously, the test chamber can be connected to an air handling system. Gases or vapors, in particular (highly) toxic gases and vapors, produced during the test or in the event of an explosion or combustion, and particles or dust or soot or the like can be removed from the test space by means of the air handling system and cleaned, if necessary, before being released into the environment. This can limit or prevent environmental damage. In addition, contamination of the further test chamber with particles, dust, soot or the like can be prevented.

Furthermore, the pressure relief device can be disposed above the test space.

Furthermore, the test chamber can have a substructure, preferably a mobile substructure, which can be disposed below the test space. The substructure can be a tubular frame. Likewise, the conditioning unit can be designed to be mobile.

Advantageously, the pressure relief device can be designed to be reversible. In other words, the pressure relief device can be designed in such a manner that it cannot be destroyed during the test or explosion, in particular not by projectiles or flying parts due to the explosion. It is therefore not necessary to replace the pressure relief device after the test or explosion. Alternatively, the pressure relief device can also be designed to be irreversible, for example with a bursting disk. However, the pressure relief device or bursting disk has to be replaced after the test or explosion in this case.

Advantageously, the pressure relief device has at least one pressure relief flap, preferably four pressure relief flaps, which can seal the test space from an environment when the pressure relief device is closed and leave it open it when the pressure relief device is open. As a result of the explosion, the pressure relief device or the pressure relief flap can be moved from the closed state to the open state, allowing the shockwave or the excess pressure to escape through an opening of the test space, preferably at the top, which is left open in the open state, to relieve the pressure of the test chamber or the test space. Advantageously, multiple pressure relief flaps can be provided. In this case, the opening can then be largely left open even with a comparatively small opening angle of the pressure relief flaps. Preferably, four pressure relief flaps can be provided. However, two, three or more than four pressure relief flaps can also be provided. A total cross-sectional area or relief area of the four pressure relief flaps can be 0.7 m2 to 0.9 m2, preferably 0.78 m2.

Advantageously, the pressure relief device can have a support frame on which the pressure relief flap can rest in the closed state. The pressure relief flap can rest on the support frame at one edge of the pressure relief flap. A seal can be provided between the pressure relief flap and the support frame to seal the test space in a gas-tight manner. The support frame can divide the opening into multiple areas according to a shape of the pressure relief flaps, in which case each pressure relief flap can close or cover one area in the closed state.

The pressure relief device can advantageously have a heater for heating the pressure relief flap and/or the support frame. This can prevent the pressure relief flap from freezing stuck on the support frame or the pressure relief flaps from freezing stuck on each other. The heater can be disposed on the support frame, in particular in such a manner that the heater can be disposed along an edge or circumference of the pressure relief flap or a support surface of the pressure relief flap. The pressure relief flap can also be heated across an entire cross-sectional area of the pressure relief flap.

The pressure relief flap can advantageously have a triangular cross section. The pressure relief flap can preferably have a cross section in the shape of an isosceles triangle with two legs and a base. The opening of the test space can be of a square shape, and the four pressure relief flaps each having the cross section in the shape of the isosceles triangle can cover the square-shaped opening in the closed state. Apices of the isosceles triangles can meet essentially at the center of the square-shaped opening. An apex is understood to be a corner point opposite a base of an isosceles triangle.

The pressure relief flap can advantageously be formed from a fiber composite material. The fiber composite material can comprise fibers and a resin in which the fibers can be cast. As a result, the pressure relief flap is mechanically stable while it can be of a lightweight construction, that is, of a comparatively low mass or a low weight, allowing the pressure relief flap to achieve a comparatively high opening speed.

Alternatively, the pressure relief flap can be made of steel-spring-strip material. This makes the test chamber or the test chamber system comparatively cheaper to produce. In this case, an air curtain, for example of dry compressed air, can be generated additionally above the pressure relief flap to prevent icing of a surface of the pressure relief flap at low temperatures, which is more likely due to the higher thermal conductivity of the spring steel-spring-strip material compared to the thermal conductivity of the fiber composite material. For this purpose, the pressure relief device can have a compressed-air device.

The pressure relief device can advantageously have a frame. The pressure relief flap can then be disposed on or attached to the frame. The pressure relief flap can be attached to the frame by means of a hinge. The pressure relief flaps can advantageously each be disposed on the frame with the base or on the base side with reference to the isosceles triangle. The frame can be a tubular frame. However, the pressure relief flap can also be attached to the test chamber.

Advantageously, the pressure relief flap can be attached to the frame by means of at least one hinge, which can have an oblong hole. The oblong hole allows the pressure relief flap to be opened relatively quickly by lifting the pressure relief flap linearly. However, the pressure relief flap can also be disposed on the frame or the test space in such a manner that it can be lifted vertically.

Advantageously, the pressure relief device can have a damper.

Advantageously, the damper can have a baffle plate or a travel limiter for stopping the pressure relief flap in the open state and a damper element for damping the baffle plate. The baffle plate or a baffle plate impact surface can be designed in such a manner that the pressure relief flap can strike the baffle plate with its entire cross-sectional area in the open state; i.e., the pressure relief flap can transfer impact energy or impact force to the baffle plate across its entire cross-sectional area. An embodiment without a baffle plate is also conceivable, meaning the pressure relief flap can strike the damper element directly when it is open.

The damper element can advantageously be an oil pressure damper, a gas pressure damper or a spring damper, for example a spiral spring.

Advantageously, the pressure relief device can have a holding member for holding the pressure relief flap in the open state. This can prevent the pressure relief flap from being damaged by heat from a fire that occurs in the test space after the explosion. For example, a mechanical catch can be provided that can be released again after the test object has burnt down.

Advantageously, the test chamber can have a preferably hydraulically driven penetration device for penetrating or destroying the test object. At least one, preferably two, hydraulic cylinder of the penetration device can be disposed below the test space in order to protect it from high temperatures; the hydraulic cylinder can be provided as a drive. Heat, fire, explosively expanding gases or the like can then escape freely upward, in particular via an exhaust air duct. A piston rod of the hydraulic cylinder can extend from the bottom to the top and protrude into the test space. If the penetration device has two hydraulic cylinders, each of the two hydraulic cylinders can have a piston rod, in which case the piston rods can be connected to each other at the end via a traverse then located in the test space. Alternatively, only a single hydraulic cylinder can be provided, in particular if a comparatively lower force is required for penetration. This makes it possible to produce the test chamber system or the penetration device more cost-effectively. In this embodiment, too, a traverse can be provided on a piston rod of the hydraulic cylinder. For example, a ring-shaped force transmission element with a rectangular cross section can be disposed on the piston rod for this purpose, in which case an upper portion of the force transmission element or an upper side of the rectangle can form the traverse. However, a pneumatic or electromechanical drive can also be provided instead of the hydraulic drive.

The penetration device can advantageously have a preferably nail-like penetration element by means of which the test object can be penetrated from above. The penetration element can be disposed on a piston rod of a hydraulic cylinder of the penetration device. In particular, the penetration element can be disposed on the traverse. The penetration element can then be pulled or pushed down into the test object from above by means of the hydraulic cylinder or hydraulic cylinders. Furthermore, a force absorption plate of the test chamber, for example several centimeters thick, can be disposed below the test space or between the test space and the substructure in order to absorb forces or tensile forces occurring during the penetration. Since the force absorption plate is disposed below the test space or between the test space and the substructure, the force absorption plate has not adverse thermal effect. Preferably, the penetration element is nail-like, i.e., pointed. Alternatively, the penetration element can also be flat or line-shaped so as to generate a surface load or a line load. A line-shaped penetration element can then be used, for example, to provoke bending of the test object. The penetration device can be designed in such a manner that a plurality of different types of penetration elements can be used interchangeably or in a modular manner. Alternatively or additionally, it is also possible for the penetration element to penetrate the test object laterally.

In the method according to the disclosure for relieving the pressure of a test chamber of a test chamber system by means of a pressure relief device of the test chamber, a test object, in particular a battery, is received in a test space of the test chamber, the test object being subjected to a test, in particular an abuse test, in the test space, as a result of which a preferably explosive increase in pressure in the test space is triggered, the pressure relief device relieving the increased pressure in the test space, a conditioning unit of the test chamber system for conditioning air being connected to the test chamber in such a manner that the conditioning unit air-conditions the test chamber.

For the advantageous effects of the method according to the disclosure, reference is made to the description of advantages of the test chamber system according to the disclosure.

Advantageously, the increase in pressure causes at least one pressure relief flap, preferably four pressure relief flaps, of the pressure relief device for relieving the pressure of the test space to be moved from a closed state of the pressure relief device, in which the pressure relief flaps can seal the test space from an environment, to an open state of the pressure relief device, in which the pressure relief flaps can leave the test space open to the environment.

Advantageously, the pressure relief device or the pressure relief flap cannot be destroyed during or as a result of the test or the explosion.

Further advantageous embodiments of the method are apparent from the descriptions of features of the claims.

### BRIEF DESCRIPTION OF THE FIGURES

Preferred embodiments of the invention are explained in more detail below with reference to the accompanying drawings.

FIG. 1 is a perspective view of a test chamber system from one side.

FIG. 2 is a perspective view of the test chamber system from another side.

FIG. 3 is a perspective view of a pressure relief device of a test chamber of the test chamber system from one side with the pressure relief device in an open state.

FIG. 4 is a perspective partial section view of the pressure relief device with the pressure relief device in a closed state.

FIG. 5 is a perspective section view of the pressure relief device in the closed state.

FIG. 6 is a perspective partial view of the test chamber from above in the open state.

FIG. 7 is a perspective view of a test chamber in a further embodiment from the front.

FIG. 8 is a perspective view of the test chamber in the other embodiment from the rear.

FIG. 9 is a perspective view of the test chamber in the other embodiment from above with a pressure relief device of the test chamber in an open state.

FIG. 10 is a perspective view of the test chamber in the other embodiment from the front with a door of a test space of the test chamber open and with a penetration device of the test chamber in the retracted state.

FIG. 11 is a perspective view of the test chamber in the other embodiment from the front with the door open and the penetration device in an extended state.

FIG. 12 is a perspective partial view of the test chamber in the other embodiment from one side in the area of a hinge of the door.

FIG. 13 is a partial sectional view of a pinned fitting of the test space.

FIG. 14 is a perspective partial section view of a test chamber in a further embodiment with a penetration device of the test chamber in a retracted state.

FIG. 15 is a perspective partial section view of the test chamber in the further embodiment with the penetration device in an extended state.

FIG. 16 is a perspective partial view of a test chamber system in another embodiment at an angle from one side.

FIG. 17 is a perspective view of the test chamber system in the other embodiment from the side.

### DETAILED DESCRIPTION

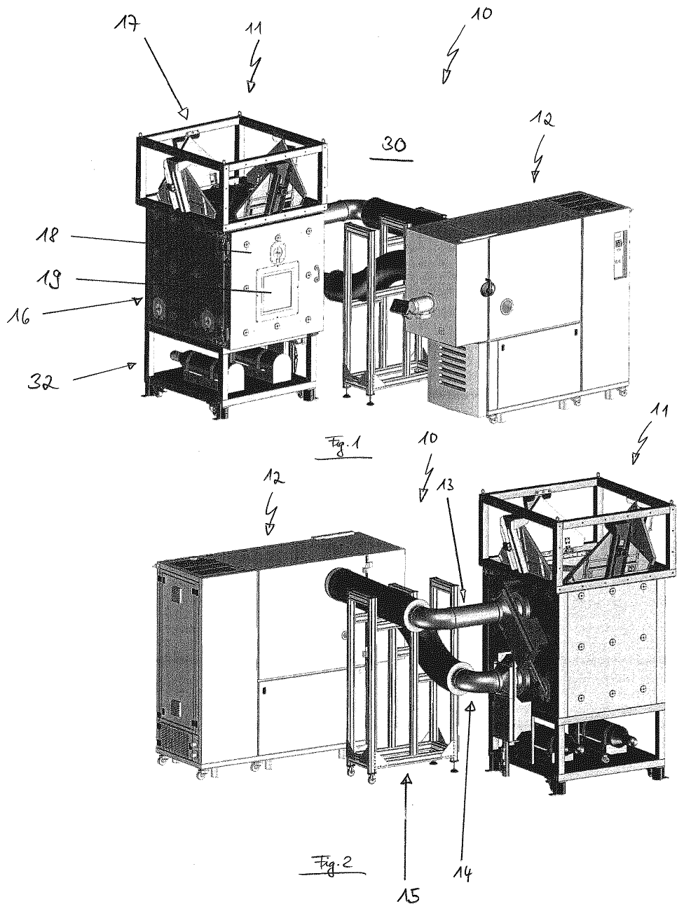

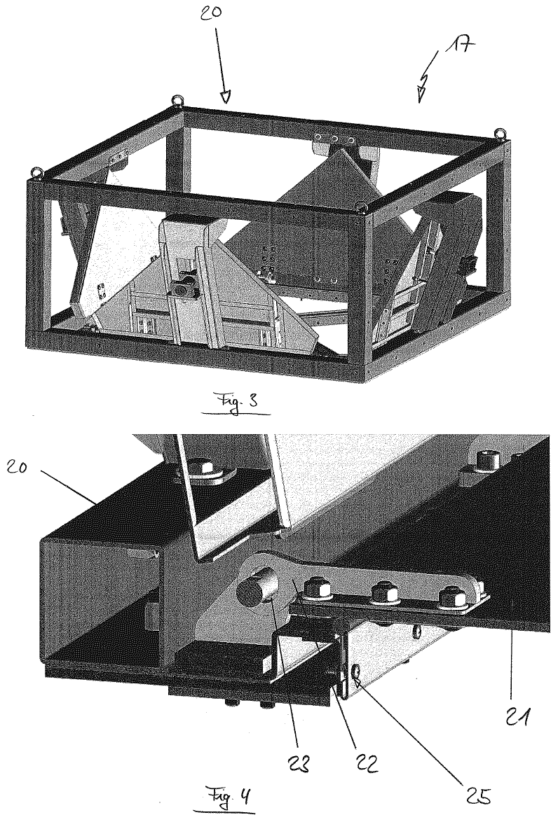

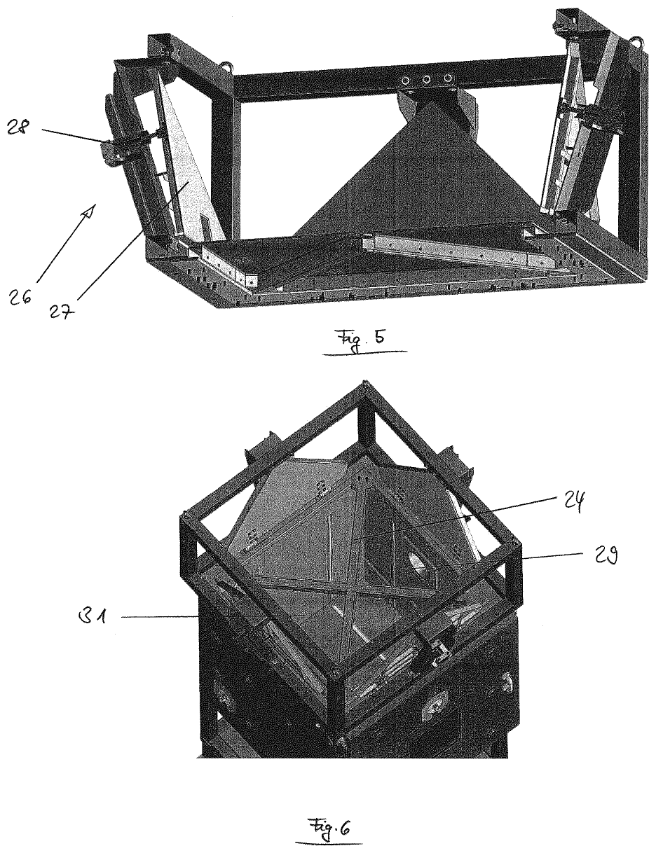

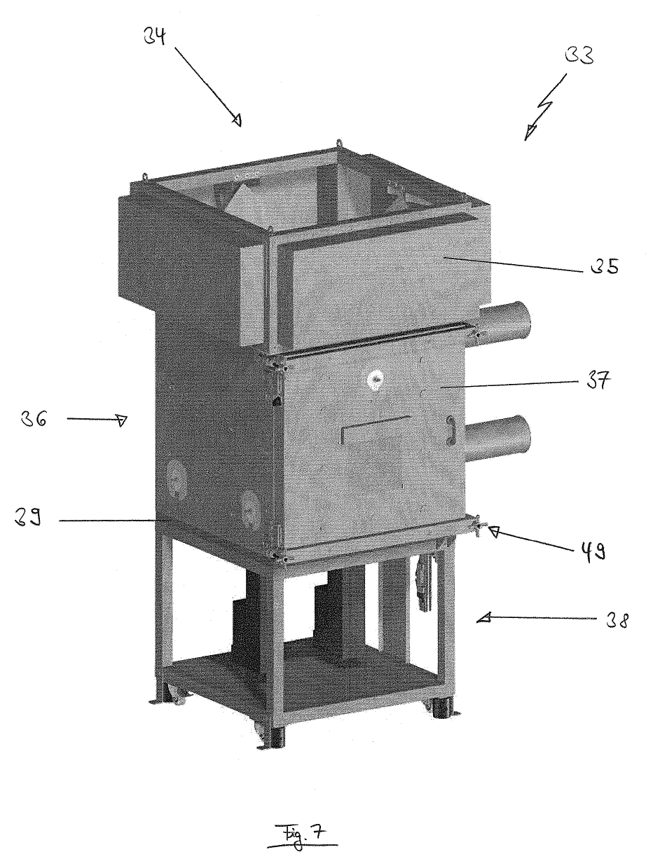

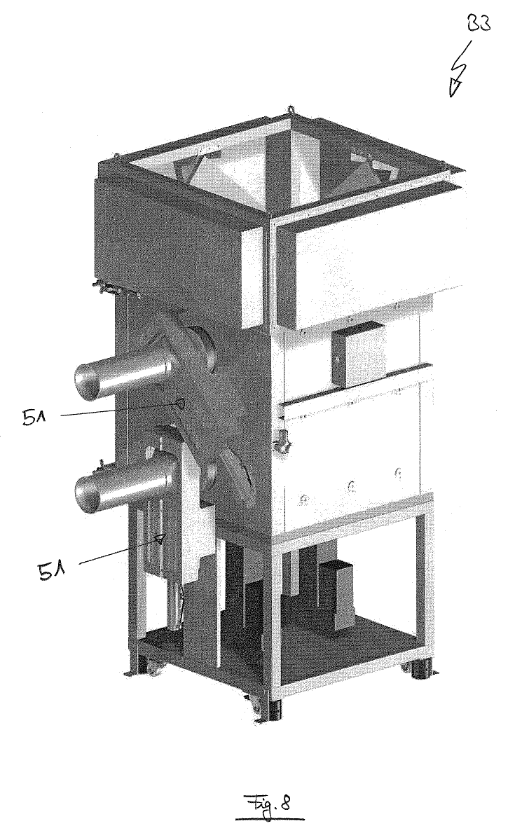

A combination of FIGS. 1 to 6 shows a test chamber system 10, which comprises a test chamber 11 and a conditioning unit 12, which forms a further test chamber, the test chamber 11 and the conditioning unit 12 being connected via a first conduit 13 and a second conduit 14 of the test chamber system 10. The first conduit 13 and the second conduit 14 are supported on a rack 15 of the test chamber system 10. The conditioning unit 12 is used to condition the test chamber 11.

The test chamber 11 has a test space 16 and a pressure relief device 17. The test space 16 has a door 18 with a window 19 on the side, and when the door 18 is open, a test object (not shown) can be introduced into the test space 16. When the door 18 is closed, the door 18 laterally seals the test space 16.

The pressure relief device 17, which is disposed above the test space 16, has a frame 20 and four pressure relief flaps 21, which are each made of a fiber composite material and each have a cross section in the shape of an isosceles triangle, the pressure relief flaps 21 each being attached to the frame 20 at the base of the isosceles triangle by means of hinges 22 of the pressure relief device 17, which have an oblong hole 23. The pressure relief device 17 further has a support frame 24, which is also attached to the frame 20 and on which the pressure relief flaps 21 rest when the pressure relief device 17 is closed. A heater 25 of the pressure relief device 17 prevents the pressure relief flaps 21 from freezing to the support frame 24 when the pressure relief device 17 is closed. Furthermore, the pressure relief device 17 has a damper 26 which has a baffle plate 27 for stopping the pressure relief flap 21 in an open state of the pressure relief device 17 and a damper element 28, which is an oil pressure damper and serves to damp the baffle plate 27, for each pressure relief flap 21. A cross section of the baffle plates 27 is essentially identical in shape and size to the cross section of the pressure relief flaps 21, so the pressure relief flaps 21 strike a baffle area of the baffle plate 27 with a total cross-sectional area of the pressure relief flaps 21 when the pressure relief device 17 is open. When the pressure relief device 17 is closed, the test space 16 or an opening 29 at the top of the test space 16 is closed or covered by the pressure relief flaps 21 with respect to an environment 30. To be more precise, the support frame 24 divides the opening 29 into four areas 31, each area 31 being closed by a pressure relief flap 21 when the pressure relief device 17 is closed. When the pressure relief device 17 is open, the test space 16, the opening 29 and the areas 31 are left open to the environment 30.

Furthermore, the test chamber 11 has a movable substructure 32, which is disposed below the test space 16.

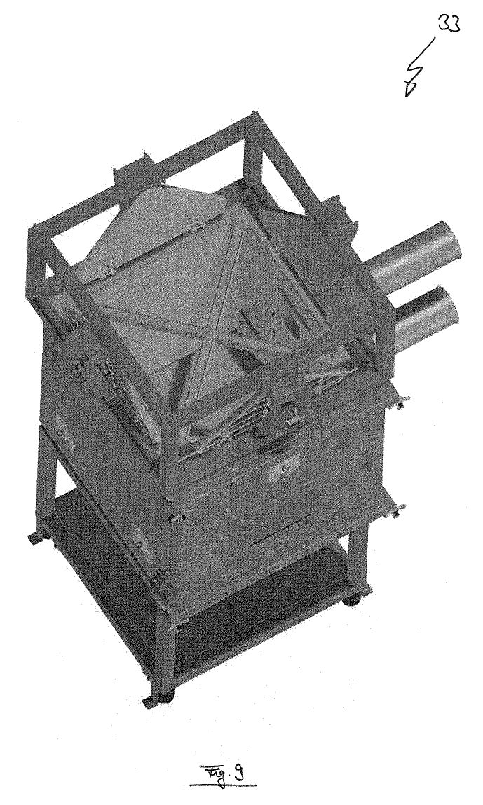

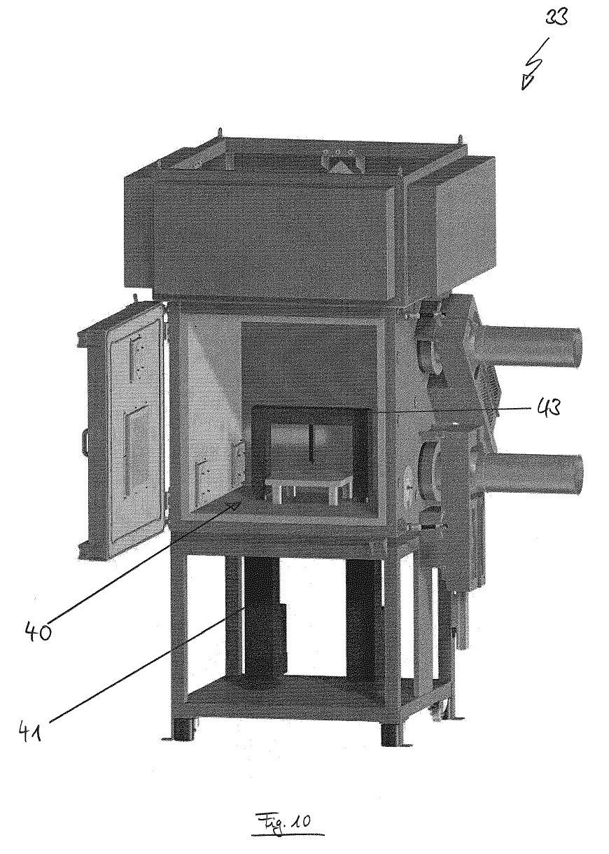

A combination of FIGS. 7 to 13 shows a test chamber 33, which is largely identical to test chamber 11. The following essentially, but not exclusively, describes the differences between the two embodiments of the test chamber. In principle, test chamber 11 can also have the features that distinguish test chamber 33 from test chamber 11. Likewise, test chamber 33 can also have the features that distinguish test chamber 11 from test chamber 33. Furthermore, test chamber 33 can be connected to the conditioning unit 12, in particular via the first conduit 13 and the second conduit 14.

The test chamber 33 has a pressure relief device 34, on the frame of which four covers 35 of the pressure relief device 34 are laterally disposed, which are not shown in FIG. 9 for reasons of visibility. The cover 35 is used in particular for the gas-tight connection of a downstream gas cleaning system.

Furthermore, the test chamber 33 has a test space 36, which can be sealed at the side by a door 37 of the test space 36. The test space 36 is disposed on a substructure 38 of the test chamber 33, a force absorption plate 39 of the test chamber 33 being disposed between the test space 36 and the substructure 38.

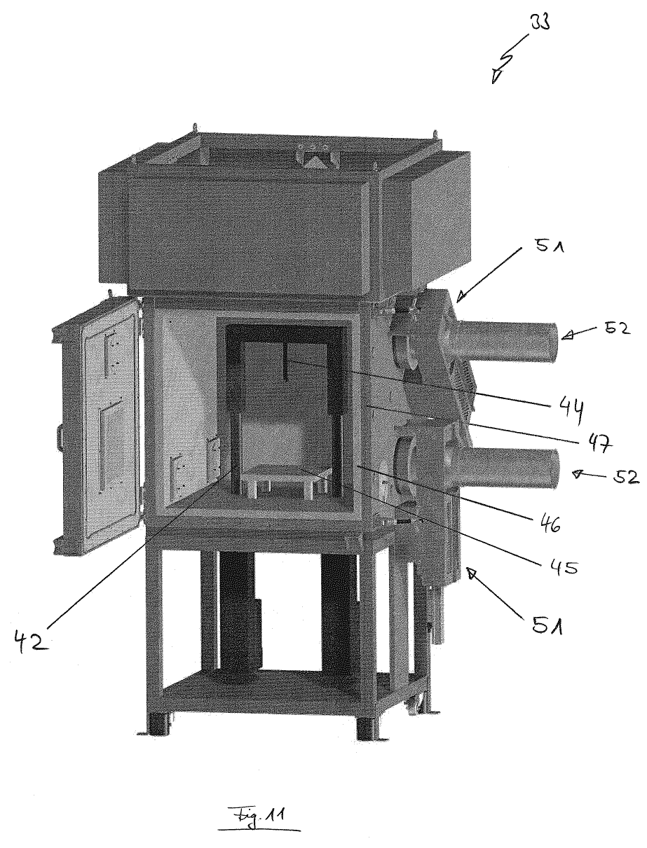

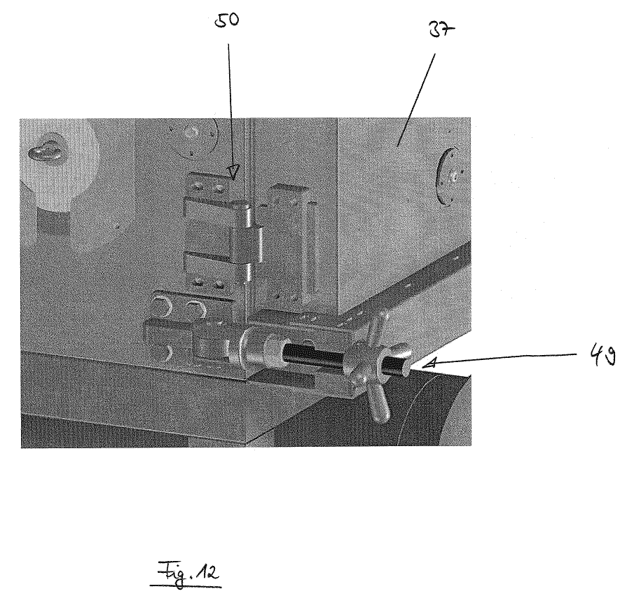

As can be seen in FIGS. 10 and 11, the test chamber 33 has a hydraulically driven penetration device 40 for penetrating a test object (not shown) which can be received in the test space 36. The penetration device 40 has two hydraulic cylinders 41 disposed below the test space 36, each of the two hydraulic cylinders 41 having a piston rod 42 extending from bottom to top and projecting into the test space 36, the piston rods 42 being connected to each other at the end via a traverse 43 located in the test space 36. Furthermore, the penetration device 40 has a nail-like penetration element 44 which is disposed on the traverse 43 and extends from top to bottom and by means of which the test object can be penetrated from above. Furthermore, a table 45 of the test space 36 is disposed in the test space 36, on which the test object can be disposed. FIG. 10 shows the penetration device 40 in a retracted state of the penetration device 40 or the hydraulic cylinders 41, and FIG. 11 shows the penetration device 40 in an extended state of the penetration device 40 or the hydraulic cylinders 41. By moving the penetration device 40 from the extended state to the retracted state, the test object, which can be disposed on the table 45, can be penetrated or destroyed, the penetration element 44 being able to penetrate the test object.

As can further be seen from FIGS. 10 and 11, the test space 36 is designed with two shells, an inner shell 46 forming an insulated test box for receiving the test object, and an outer shell 47 forming a housing enclosing the test box. The test box to be temperature-controlled is of a lightweight construction with as low a mass as possible, as a result of which the test box can be temperature-controlled or its temperature can be changed in a thermally favorable manner. The test box is connected to the housing via a pinned fitting 48, which is shown in FIG. 13.

Furthermore, pipe gates 51 of the test space 36 are provided in connections 52 of the test space 36, which serve to channel supply air or exhaust air, in order to prevent the destruction of a conditioning unit (not shown) which can be connected to the connections 52.

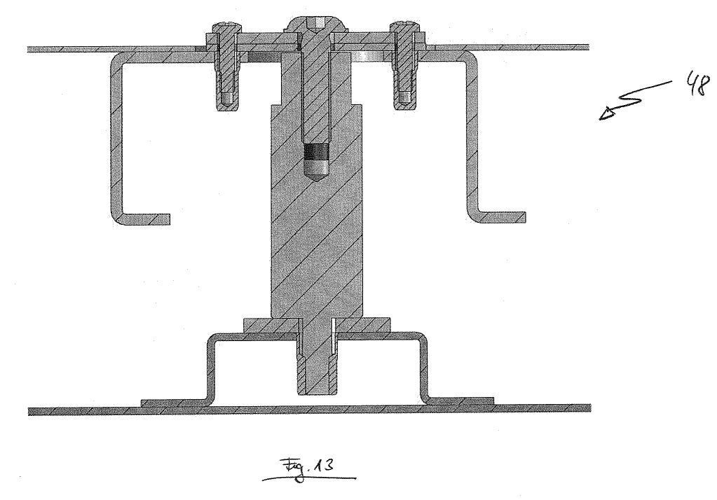

Furthermore, the test space 33 has four length compensation hinges 49 for providing contact pressure of the door 37. FIG. 12 shows a partial perspective view of the test chamber 33 and the test space 36 in the area of a hinge 50 of the door 37 from one side, from which one of the length compensation hinges 49 can be clearly seen.

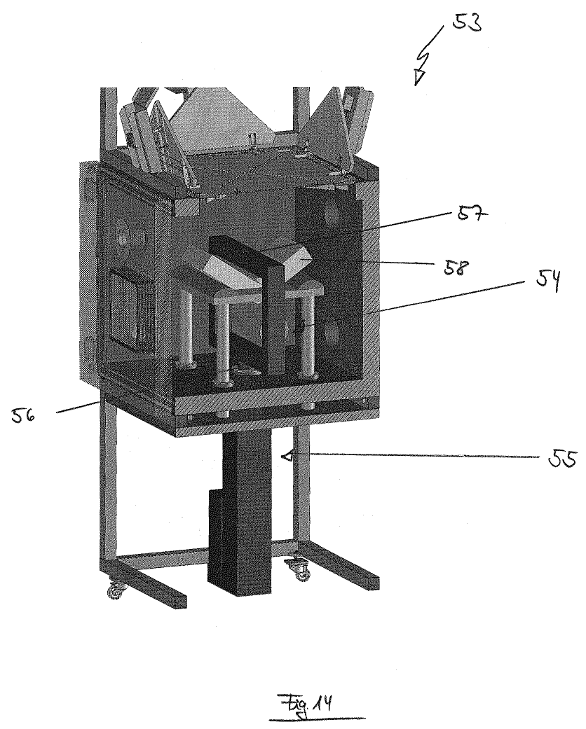

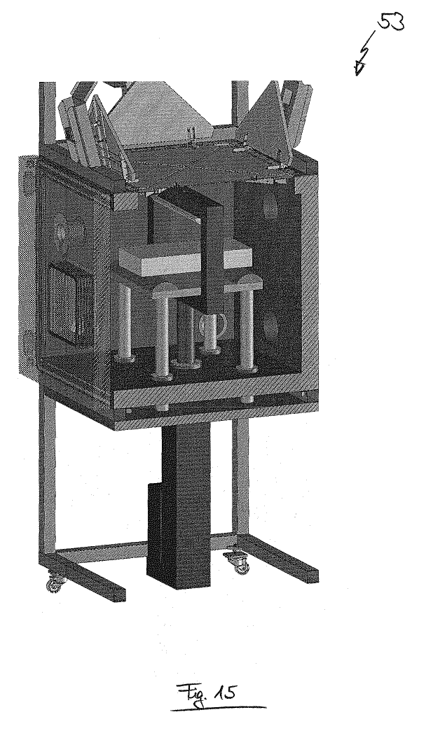

A combination of FIGS. 14 and 15 shows a test chamber 53, which essentially differs from test chamber 33 in that a penetration device 54 of test chamber 53 has only a single hydraulic cylinder 55. A traverse 57 is provided on a piston rod 56 of the hydraulic cylinder 55, with which a test object 58 can be penetrated from above. Reference is also made to the other figure descriptions.

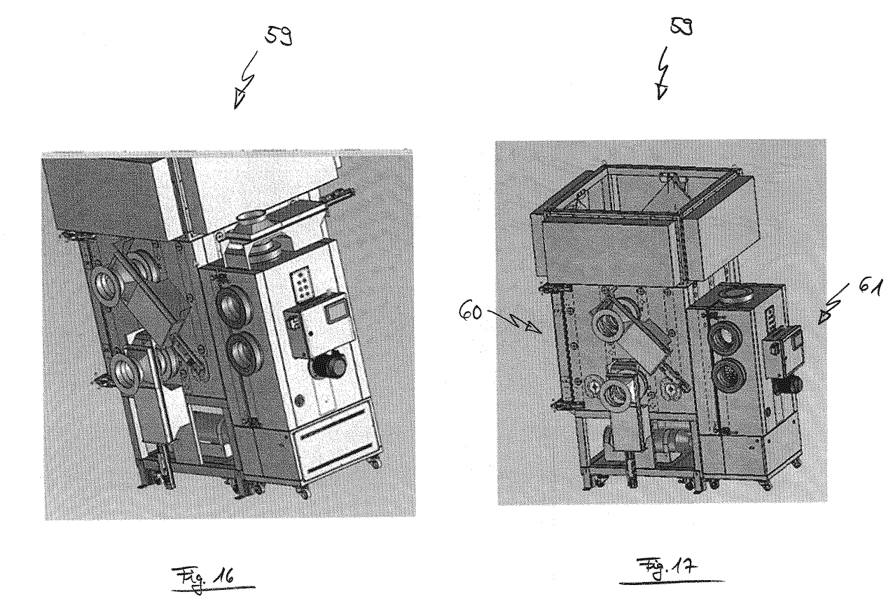

A combination of FIGS. 16 and 17 shows a test chamber system 59 comprising a test chamber 60 and a conditioning unit 61 which is configured as a convection heating device and which is directly disposed on or attached to the side of the test chamber 60 and which can be connected to the test chamber 60 via conduits (not shown) of the test chamber system 59. Reference is also made to the other figure descriptions.

1. A test chamber system comprising a test chamber, the test chamber having a test space for receiving a test object, in particular a battery, and a pressure relief device, the test space serving to subject the test object to a test, in particular an abuse test, as a result of which a preferably explosive increase in pressure is triggered in the test space, the pressure relief device being configured to relieve the increased pressure in the test space, the test chamber system comprising a conditioning unit for conditioning air, the conditioning unit being connected to the test chamber in such a manner that the conditioning unit is able to air-condition the test chamber.

2. The test chamber system according to claim 1, wherein the test chamber system comprises at least one conduit which connect the conditioning unit to the test chamber.

3. The test chamber system according to claim 1, wherein the conditioning unit forms a further test chamber, in particular a climate chamber, which has a further test space for receiving test material, the further test space being configured to be sealed from an environment and being temperature-insulated.

4. The test chamber system according to claim 1, wherein the conditioning unit has a temperature control device.

5. The test chamber system according to claim 4, wherein the temperature control device is configured to establish a temperature in a temperature range of −70° C. to +180° C.

6. The test chamber system according to claim 4, wherein the temperature control device has a cooling device comprising a cooling circuit with a refrigerant, a heat exchanger, a compressor, a condenser, and an expansion member.

7. The test chamber system according to claim 4, wherein the temperature control device has a heating device comprising a heater and a further heat exchanger.

8. The test chamber system according to claim 1, wherein the conditioning unit is a heating device, in particular a convection heating device or a hot-air gun.

9. The test chamber system according to claim 1, wherein the conditioning unit has a control device for controlling and/or regulating a temperature.

10. The test chamber system according to claim 1, wherein the pressure relief device has at least one pressure relief flap sealing the test space from an environment when the pressure relief device is closed and leaving the test space open when the pressure relief device is open.

11. The test chamber system according to claim 10, wherein the pressure relief device has a support frame on which the pressure relief flap rests in the closed state.

12. The test chamber system according to claim 11, wherein the pressure relief device has a heater for heating the pressure relief flap and/or the support frame.

13. The test chamber system according to claim 10, wherein the pressure relief flap has a triangular cross section.

14. The test chamber system according to claim 10, wherein the pressure relief flap is made of a fiber-composite material.

15. The test chamber system according to claim 10, wherein the pressure relief flap is made of a steel-spring-strip material.

16. The test chamber system according to claim 10, wherein the pressure relief device has a frame.

17. The test chamber system according to claim 16, wherein the pressure relief flap is attached to the frame by at least one hinge, which has an oblong hole.

18. The test chamber system according to claim 10, wherein the pressure relief device has a damper.

19. The test chamber system according to claim 18, wherein the damper has a baffle plate for stopping the pressure relief flap in the open state and a damper element for damping the baffle plate.

20. The test chamber system according to claim 19, wherein the damper element is an oil pressure damper, a gas pressure damper or a spring damper.

21. The test chamber system according to claim 10, wherein the pressure relief device has a holding member for holding the pressure relief flap in the open state.

22. The test chamber system according to claim 1, wherein the test chamber has a penetration device for penetrating the test object.

23. The test chamber system according to claim 22, wherein the penetration device has a penetration element configured to penetrate the test object from above.

24. A method for relieving pressure in a test chamber of a test chamber system using a pressure relief device of the test chamber, a test space of the test chamber receiving a test object, in particular a battery, the test object being subjected to a test, in particular an abuse test, in the test space, as a result of which a preferably explosive increase in pressure is triggered in the test space, the pressure relief device relieving the increased pressure in the test space, a conditioning unit of the test chamber system for conditioning air being connected to the test chamber in such a manner that the conditioning unit air-conditions the test chamber.

25. The method according to claim 24, wherein the increase in pressure causes at least one pressure relief flap of the pressure relief device to move from a closed state of the pressure relief device, in which the pressure relief flap seals the test space from an environment, into an open state of the pressure relief device, in which the pressure relief flap leaves the test space open to the environment, so as to relieve the pressure in the test space.

26. The method according to claim 24, wherein the pressure relief device is not destroyed in the course of the test.
